(19) United States
(12) Patent Application Publication
(10) Pub. No.: US 2023/0180108 A1
(43) Pub. Date: Jun. 8, 2023

(54) WIRELESS COMMUNICATION SYSTEM AND WIRELESS COMMUNICATION METHOD

(71) Applicant: PANASONIC HOLDINGS CORPORATION, Osaka (JP)

(72) Inventors: Yoichi NAKAGAWA, Tokyo (JP); Masataka IRIE, Kanagawa (JP); Noriyuki SHIMIZU, Kanagawa (JP)

(73) Assignee: PANASONIC HOLDINGS CORPORATION, Osaka (JP)

(21) Appl. No.: 17/913,061

(22) PCT Filed: Jan. 28, 2021
(86) PCT No.: PCT/JP2021/002988

§ 371 Date: Sep. 20, 2022

(30) Foreign Application Priority Data
Mar. 26, 2020 (JP) 2020-055525

(51) Int. Cl. H04W 48/16; G08G 1/0967; H04W 76/10

(52) U.S. Cl. CPC H04W 48/16; G08G 1/096783; H04W 76/10

(57) ABSTRACT

To secure a line of sight (LOS) in wireless communication between a mobile communication device mounted on a moving object and a fixed communication device provided on a travel route of the moving object, a wireless communication system includes an LOS determiner that determines whether line of sight between the mobile communication device and the fixed communication device is secured based on position information of the fixed communication device and position information of the mobile communication device, and a travel condition determiner that, when it is determined by the LOS determiner that the line of sight is not secured, determines a travel condition of the moving object for securing the line of sight.

### TECHNICAL FIELD

The present disclosure relates to a wireless communication system and a wireless communication method for performing wireless communication between a mobile communication device, which is a communication device mounted on a moving object, and a fixed communication device, which is a communication device provided on a travel route of the moving object.

### BACKGROUND ART

Conventionally, for the purpose of preventing decrease of communication speed due to traffic increase or the like, a technology for improving the off-load effect in mobile communication is being developed. For example, there is known a mobile system communication apparatus including: a travel route management section that predicts a predicted position of a mobile terminal, a target communication quality determination section that determines a target communication quality based on the requested communication quality for the transmission data, a communication quality prediction section that predicts a predicted communication quality which is predicted when communication is performed with an advantageous communication characteristic that is more advantageous than the present communication characteristic, and a selection section which, based on a result of comparison between the target communication quality and the predicted communication quality, selects data transmission with the present communication characteristic or data transmission with the advantageous communication characteristic (see Patent Document 1).

### PRIOR ART DOCUMENT(S)

### Patent Document(s)

[Patent Document 1] JP2019-140563A

### SUMMARY OF THE INVENTION

### Task to be Accomplished by the Invention

In the next-generation mobile communication that is being introduced in recent years, by using a higher frequency band that has not been used so far, such as the high SHF band and EHF band, large volume communication is realized. In the communication method that uses such a high frequency band, large volume communication can be realized, but since the radio waves have high straightness, there is a problem that wireless communication quality deteriorates if there is another object (shield) on the communication path.

Particularly, in wireless communication between a mobile communication device mounted on a moving object and a fixed communication device provided on a travel route of the moving object, since the timing at which the communication is possible is limited due to movement of the moving object, it is desirable to properly secure a line of sight (LOS) (namely, properly avoid blocking of the line of sight) between the mobile communication device and the fixed communication device (more specifically, between the communication antennas of them).

However, in the conventional technology disclosed by the aforementioned Patent Document 1, there was no consideration on securing of such line of sight (namely, the line of sight may be blocked).

In view of the above, a primary object of the present disclosure is to provide a wireless communication system and a wireless communication method which, in wireless communication between a mobile communication device mounted on a moving object and a fixed communication device provided on a travel route of the moving object, can secure a line of sight (LOS) between them.

### Means to Accomplish the Task

The wireless communication system of the present disclosure is a wireless communication system for performing wireless communication between a mobile communication device mounted on a moving object and a fixed communication device provided on a travel route of the moving object, the system comprising: an LOS determiner that determines whether a line of sight between the mobile communication device and the fixed communication device is secured based on position information of the fixed communication device and position information of the mobile communication device; and a travel condition determiner that, when it is determined by the LOS determiner that the line of sight is not secured, determines a travel condition of the moving object for securing the line of sight.

The wireless communication method of the present disclosure is a wireless communication method for performing wireless communication between a mobile communication device mounted on a moving object and a fixed communication device provided on a travel route of the moving object, the method comprising: determining whether a line of sight between the mobile communication device and the fixed communication device is secured based on position information of the fixed communication device and position information of the mobile communication device; and determining a travel condition of the moving object for securing the line of sight when it is determined that the line of sight is not secured.

### Effect of the Invention

According to the present disclosure, in wireless communication between a mobile communication device mounted on a moving object and a fixed communication device provided on a travel route of the moving object, it is possible to secure a line of sight between them.

### BRIEF DESCRIPTION OF THE DRAWINGS

FIG. 1 is an overall configuration diagram of a wireless communication system according to the first embodiment;

FIG. 2 is a functional block diagram of the wireless communication system according to the first embodiment;

FIG. 3 is a flowchart showing a flow of process for securing a line of sight of wireless communication according to the first embodiment;

FIG. 4 is an explanatory diagram for showing a first example of travel control of the vehicle according to the first embodiment;

FIG. 5 is an explanatory diagram for showing a second example of travel control of the vehicle according to the first embodiment;

FIG. 6 is a flowchart showing a flow of process for securing a line of sight of wireless communication according to the second embodiment;

FIG. 7 is an explanatory diagram for showing an example of a connection process for connecting an onboard device to a roadside device according to the second embodiment;

FIG. 8 is a functional block diagram of a wireless communication system 1 according to the third embodiment;

FIG. 9 is a flowchart showing a flow of process for securing a line of sight of wireless communication according to the third embodiment;

FIG. 10 is a functional block diagram of a wireless communication system according to the fourth embodiment;

FIG. 11 is a flowchart showing a flow of process for securing a line of sight of wireless communication according to the fourth embodiment;

FIG. 12 is a flowchart showing a flow of process for securing a line of sight of wireless communication according to the fifth embodiment; and

FIG. 13 is a flowchart showing a flow of process for securing a line of sight of wireless communication according to the sixth embodiment.

### MODE(S) FOR CARRYING OUT THE INVENTION

A first aspect of the present invention made to achieve the above-described object is a wireless communication system for performing wireless communication between a mobile communication device mounted on a moving object and a fixed communication device provided on a travel route of the moving object, the system comprising: an LOS determiner that determines whether a line of sight between the mobile communication device and the fixed communication device is secured based on position information of the fixed communication device and position information of the mobile communication device; and a travel condition determiner that, when it is determined by the LOS determiner that the line of sight is not secured, determines a travel condition of the moving object for securing the line of sight.

According to this, when it is determined that the line of sight between the fixed communication device and the mobile communication device is not secured, a travel condition of the moving object for securing the line of sight is determined, and therefore, it is possible to secure the line of sight (LOS) in the wireless communication between the mobile communication device mounted on the moving object and the fixed communication device provided on the travel route of the moving object.

In a second aspect of the present invention, the wireless communication system further comprises a mobile-side communication controller that is mounted on the moving object and controls a connection process for connecting the mobile communication device to the fixed communication device, wherein the mobile-side communication controller executes the connection process only when it is determined by the LOS determiner that the line of sight is secured.

According to this, it is possible to prevent the mobile communication device from executing the connection process for connecting to the fixed communication device in a state in which the communication environment is bad (the line of sight is not secured).

In a third aspect of the present invention, the position information of the fixed communication device is based on position of an antenna provided on the fixed communication device.

According to this, since the accuracy of the position information of the fixed communication device is increased, it is possible to more reliably secure the line of sight in the wireless communication between the mobile communication device and the fixed communication device.

In a fourth aspect of the present invention, the position information of the mobile communication device includes a position coordinate of the mobile communication device in three-dimensional map information.

According to this, since the accuracy of the position information of the mobile communication device is increased, it is possible to more reliably secure the line of sight in the wireless communication between the mobile communication device and the fixed communication device.

In a fifth aspect of the present invention, the position information of the fixed communication device includes a position coordinate of the fixed communication device in the three-dimensional map information, and the LOS determiner determines that the line of sight is not secured when there is another object on a straight line connecting the position coordinate of the fixed communication device and the position coordinate of the mobile communication device.

According to this, it is possible to more accurately determine whether the line of sight between the mobile communication device and the fixed communication device is secured.

In a sixth aspect of the present invention, the wireless communication system further comprises an image sensing device that is mounted on the moving object and captures an image of the fixed communication device thereby to generate a captured image, wherein the LOS determiner determines whether the line of sight between the mobile communication device and the fixed communication device is secured based on the captured image.

According to this, it is possible to more accurately determine whether the line of sight between the mobile communication device and the fixed communication device is secured based on an object included in the captured image.

In a seventh aspect of the present invention, the position information of the fixed communication device is based on a position of a guide sign installed together with the antenna.

According to this, it is possible to easily acquire the position information of the fixed communication device based on the position of the guide sign included in the three-dimensional map information.

In an eighth aspect of the present invention, the moving object is an autonomous vehicle, and the travel condition includes at least one of a velocity of the autonomous vehicle, an inter-vehicle distance to another vehicle traveling ahead, and a traveling lane.

According to this, it is possible to more easily secure the line of sight between the mobile communication device and the fixed communication device based on the travel condition such as the velocity of the autonomous vehicle, the inter-vehicle distance to another vehicle, and/or the traveling lane.

In a ninth aspect of the present invention, the fixed communication device transmits a beacon signal to surroundings at a predetermined period and is further provided with a beacon controller that sets transmission timing of the beacon signal, and the mobile-side communication controller controls the connection process for connecting the mobile communication device to the fixed communication device so as to synchronize with the transmission timing of the beacon signal.

According to this, because the connection process is controlled to synchronize with the transmission timing of the beacon signal, the mobile communication device can quickly and stably execute the connection process for connecting to the fixed communication device.

In a tenth aspect of the present invention, the wireless communication system further comprises a sleep controller for placing the fixed communication device into hibernation, wherein the LOS determiner cancels the determination when the fixed communication device is in hibernation.

According to this, the fixed communication device can be put into hibernation in a time zone in which the communication traffic is low, such as night time, thereby to save electric power. Also, the mobile communication device can avoid useless execution of connection process for connecting to the fixed communication device in hibernation.

In an eleventh aspect of the present invention, the mobile-side communication controller acquires information on the transmission timing of the beacon signal together with a dynamic map provided from outside the wireless communication system.

According to this, it is possible to easily acquire information on the transmission timing of the beacon signal.

In a twelfth aspect of the present invention, the mobile-side communication controller acquires information on whether the mobile communication device is in hibernation together with a dynamic map provided from outside the wireless communication system.

According to this, it is possible to easily acquire information on whether the mobile communication device is in hibernation.

In a thirteenth aspect of the present invention, the mobile communication device acquires the position information of the mobile communication device together with a dynamic map provided from outside the wireless communication system.

According to this, it is possible to easily acquire the position information of the mobile communication device.

A fourteenth aspect of the invention is a wireless communication method for performing wireless communication between a mobile communication device mounted on a moving object and a fixed communication device provided on a travel route of the moving object, the method comprising: determining whether a line of sight between the mobile communication device and the fixed communication device is secured based on position information of the fixed communication device and position information of the mobile communication device; and determining a travel condition of the moving object for securing the line of sight when it is determined that the line of sight is not secured.

According to this, when it is determined that the line of sight between the fixed communication device and the mobile communication device is not secured, a travel condition of the moving object for securing the line of sight is determined, and therefore, it is possible to secure the line of sight (LOS) in the wireless communication between the mobile communication device mounted on the moving object and the fixed communication device provided on the travel route of the moving object.

Embodiments of the present disclosure will be described below with reference to the drawings.

### First Embodiment

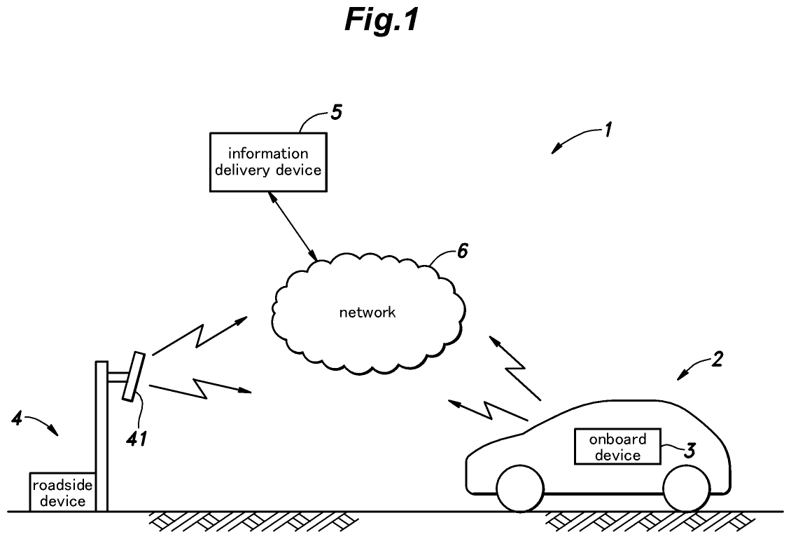

FIG. 1 is an overall configuration diagram of a wireless communication system 1 according to the first embodiment.

The wireless communication system 1 includes a mobile communication device mounted on a moving object and a fixed communication device that is provided on a travel route of the moving object and performs wireless communication with the mobile communication device. In the present embodiment, description will be made of an example in which an onboard device 3 having a wireless communication function and mounted on a vehicle 2 (moving object) performs wireless communication with a roadside device 4 having a wireless function and provided on a travel route of the vehicle 2 in the wireless communication system 1. The vehicle 2 is an autonomous vehicle, for example.

The wireless communication system 1 further includes an information delivery device 5. The information delivery device 5 is connected to the onboard device 3 and the roadside device 4 via a network 6 in a communicable manner The information delivery device 5 appropriately delivers information related to the wireless communication environment between the onboard device 3 and the roadside device 4 (hereinafter referred to as the communication infrastructure information) to the onboard device 3.

In FIG. 1, for the sake of convenience of explanation, a single vehicle 2, a single roadside device 4, and a single information delivery device 5 are shown, but each may be plural in number. For example, multiple roadside devices 4 are provided on a planned travel route of a single vehicle 2 at a predetermined interval, and these roadside devices 4 are used when other vehicles travel.

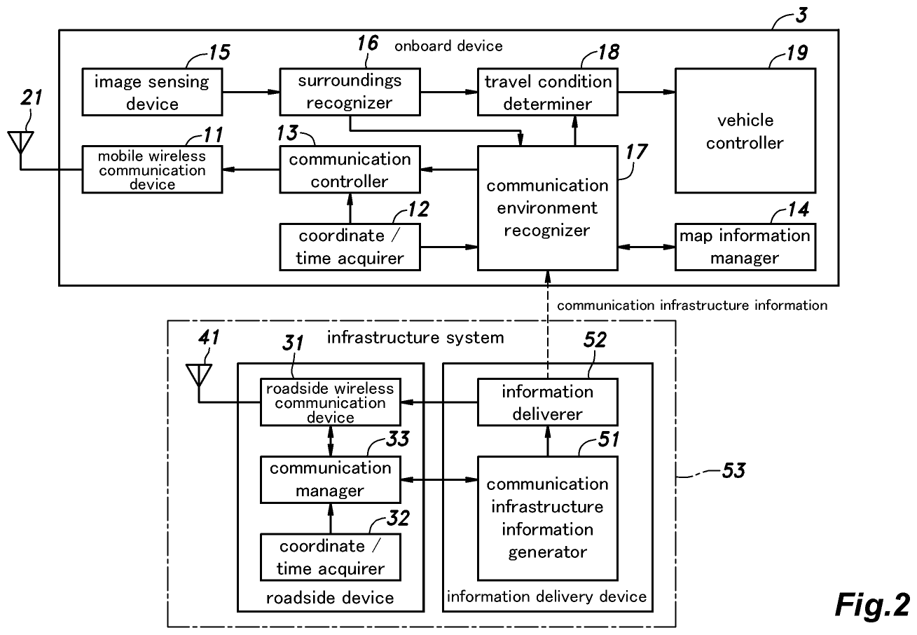

FIG. 2 is a functional block diagram of the wireless communication system 1.

The onboard device 3 includes a mobile wireless communication device 11, a coordinate/time acquirer 12, a communication controller 13 (mobile-side communication controller), a map information manager 14, an image sensing device 15, a surroundings recognizer 16, a communication environment recognizer 17 (LOS determiner), a travel condition determiner 18, and a vehicle controller 19.

The mobile wireless communication device 11 is constituted of a wireless communication device (mobile communication device) provided with an onboard antenna 21. As such a wireless communication device, a communication device conforming to a known communication standard is used. The mobile wireless communication device 11 performs wireless communication with a roadside device 4 (roadside wireless communication device 31) that has come within a communicable range due to movement (for example, travel) of the vehicle 2. The wireless communication between the mobile wireless communication device 11 and the roadside device 4 is performed directly according to a communication standard (for example, IEEE 802.11ad) that uses a relatively high frequency band (for example, 57 to 66 GHz).

The coordinate/time acquirer 12 acquires information on the global coordinate of the vehicle 2 and information on the standard time. For example, the coordinate/time acquirer 12 has a function of receiving a positioning signal and can calculate each of the global coordinate of the vehicle 2 and the standard time based on the received positioning signal and the transmission time thereof. The positioning signal includes a GNSS (Global Navigation Satellite System) signal, a GPS (Global Positioning System) signal, and the like. The coordinate/time acquirer 12 sends the information on the standard time to the communication controller 13 as necessary. Also, the coordinate/time acquirer 12 sends the global coordinate of the vehicle 2 and the standard time to the communication environment recognizer 17 as necessary.

The communication controller 13 controls the wireless communication performed by the mobile wireless communication device 11. More specifically, the communication controller 13 executes a connection process for connecting to the roadside wireless communication device 31 according to a result of later-described line-of-sight determination performed by the communication environment recognizer 17. The communication controller 13 can execute the connection process for connecting to the roadside wireless communication device 31 only when it is determined by the communication environment recognizer 17 that the line of sight is secured. Also, when it is determined by the communication environment recognizer 17 that the line of sight is not secured, the communication controller 13 can execute the connection process for connecting to the roadside wireless communication device 31 after a travel operation of the vehicle 2 for securing the line of sight is executed, as described later.

The map information manager 14 manages (records, updates) three-dimensional map information including the travel route of the vehicle 2. the map information manager 14 sends the three-dimensional map information to the communication environment recognizer 17. The three-dimensional map information is stored in a storage device (or a memory) provided in the onboard device 3 or the like.

The image sensing device 15 is constituted of a camera (for example, a stereo camera) that captures an image of a situation in the traveling direction of the vehicle 2 thereby to generate a captured image.

The surroundings recognizer 16 recognizes objects around the vehicle 2 based on the image captured by the image sensing device 15. Surrounding objects may include another vehicle traveling ahead, a road surface (lane), guide signs (including road signs and traffic lights), the roadside device 4 (particularly, a roadside device antenna 41), etc. Also, the surroundings recognizer 16 can measure the distance between each surrounding object and the own vehicle based on the captured image. The surroundings recognizer 16 sends the recognition result of each object and the measurement result of the distance between each object and the own vehicle to the communication environment recognizer 17.

The communication environment recognizer 17 reflects the position coordinate of the roadside device antenna 41 included in communication infrastructure information received from the information delivery device 5, which will be described later, in the three-dimensional map information acquired from the map information manager 14. Thereby, position information of the roadside device antenna 41 is added to the three-dimensional map information.

Further, the communication environment recognizer 17 calculates the position coordinate of the onboard antenna 21 (position information of the mobile communication device) based on the global coordinate of the vehicle 2. At this time, the communication environment recognizer 17 can correct the position coordinate of the onboard antenna 21 based on the information on the mounting position of the onboard antenna 21 acquired beforehand.

Further, the communication environment recognizer 17 performs the line-of-sight determination related to wireless communication based on the position coordinate of the onboard antenna 21 and the position coordinate of the roadside device antenna 41 (position information of the fixed communication device). In this line-of-sight determination, it is determined whether the line of sight between the mobile wireless communication device 11 (the onboard antenna 21) and the roadside wireless communication device 31 (the roadside device antenna 41) is secured. For example, the communication environment recognizer 17 may determine that the line of sight is not secured when there is another object on the straight line connecting the position coordinate of the onboard antenna 21 and the position coordinate of the roadside device antenna 41. Conversely, the communication environment recognizer 17 may determine that the line of sight is secured when there is no another object on the straight line. Note that the communication environment recognizer 17 may perform the line-of-sight determination related to wireless communication based on the coordinates of the representative positions of the onboard device 3 and the roadside device 4 (for example, the center of gravity position).

Further, the communication environment recognizer 17 can perform the line-of-sight determination related to wireless communication based on the image captured by the image sensing device 15. More specifically, the communication environment recognizer 17 executes an image recognition process on the captured image, and can determine that the line of sight is secured when the roadside device antenna 41 (or an alternative thereto) could be recognized from the captured image. If it is difficult to recognize the roadside device antenna 41 in the captured image, it is possible to provide an LED lamp or the like (an alternative) on the roadside device antenna 41 so that the communication environment recognizer 17 can recognizes the LED lamp in the image recognition process.

Such line-of-sight determination based on the captured image may be performed together with the line-of-sight determination related to wireless communication or alternatively to the line-of-sight determination related to wireless communication. When the communication environment recognizer 17 perform the line-of-sight determination based on the captured image and the line-of-sight determination related to wireless communication together, the communication environment recognizer 17 can determine that the line of sight between the mobile wireless communication device 11 and the roadside wireless communication device 31 is secured only when that the results of both determinations (tentative determinations) indicate that the line of sight is secured.

The travel condition determiner 18 determines a travel condition of the vehicle 2 for securing the line of sight when it is determined by the line-of-sight determination performed by the communication environment recognizer 17 that the line of sight is not secured. The determined travel condition includes the velocity of the vehicle 2, an inter-vehicle distance to another vehicle traveling ahead, and the lane on which the vehicle 2 is traveling, etc.

The vehicle controller 19 controls the travel of the vehicle 2 according to the travel condition determined by the travel condition determiner 18. More specifically, the vehicle controller 19 sets a target value of each parameter related to the determined travel condition. Further, the vehicle controller 19 determines operation amounts of the handle operation (steering), driving force, braking, etc. of the vehicle 2 to follow the target values, and executes the control. Note that the operation amounts of the handle operation, driving force, braking, etc. of the vehicle 2 may be set as the travel condition by the travel condition determiner 18 and sent from the travel condition determiner 18 to the vehicle controller 19. The vehicle controller 19 may be configured by multiple control devices corresponding to various operations of the vehicle 2.

At least part of the functions of the parts 11-19 of the onboard device 3 is realized by executing programs stored in a memory by one or multiple processors.

The roadside device 4 includes a roadside wireless communication device 31, a coordinate/time acquirer 32, and a communication manager 33 (beacon controller).

The roadside wireless communication device 31 is constituted of a wireless communication device (fixed communication device) provided with a roadside device antenna 41. The roadside wireless communication device 31 performs wireless communication with the mobile wireless communication device 11 of the vehicle 2 that has come within a communicable range. Also, the roadside wireless communication device 31 can transmit a beacon signal to the surroundings at a predetermined period. By receiving the beacon signal, the mobile wireless communication device 11 can acquire various information (channel (frequency), identification information in the network, beacon transmission interval, security information, etc. of the roadside wireless communication device 31) for connecting to the roadside wireless communication device 31.

The coordinate/time acquirer 32 acquires information on the global coordinate of the roadside device 4 and information on the standard time. The coordinate/time acquirer 32 has a function of receiving a positioning signal, and based on the received positioning signal and the transmission time thereof, can calculate the global coordinate of the roadside device 4 and the standard time. The coordinate/time acquirer 32 sends out the global coordinate and the standard time to the communication controller 13, as necessary.

The communication manager 33 controls the wireless communication performed by the roadside wireless communication device 31. More specifically, the communication manager 33 a connection process for connecting between the mobile wireless communication device 11 and the roadside wireless communication device 31. Also, the communication manager 33 calculates the position coordinate of the roadside device antenna 41 based on the global coordinate of the roadside device 4. At this time, the communication manager 33 can correct the position coordinate of the roadside device antenna 41 based on the information on the mounting position (particularly, the height) of the roadside device antenna 41 acquired beforehand. Also, the communication manager 33 acquires the information on the standard time and manages the information together with the information on the global coordinate of the roadside device 4. Further, when the roadside device antenna 41 is installed (in the vicinity) together with a guide sign (for example, traffic light), the communication manager 33 may determine the position coordinate of the roadside device antenna 41 based on the position coordinate of the guide sign (an alternative).

Further, the communication manager 33 can set the transmission timing (transmission time) of the beacon signal. The communication manager 33 sends the position coordinate of the roadside device antenna 41, the information on the standard time, and the information on the transmission time of the beacon signal to the information delivery device 5, as necessary.

At least part of the functions of the parts 31-33 of the roadside device 4 is realized by executing programs stored in a memory by one or multiple processors.

The information delivery device 5 includes a communication infrastructure information generator 51 and an information deliverer 52. For example, the information delivery device 5 is configured by a cloud server. The roadside device 4 and the information delivery device 5 constitute an infrastructure system 53 which provides a basis for the vehicle 2 to perform wireless communication.

The communication infrastructure information generator 51 generates communication infrastructure information to be delivered to the onboard device 3. This communication infrastructure information includes information related to the communication environment of the mobile wireless communication device 11 of the onboard device 3. Here, the communication infrastructure information includes the position coordinate of the roadside device antenna 41 acquired from the roadside device 4. Also, the communication infrastructure information may include the transmission time of the beacon signal transmitted from the roadside device antenna 41.

The information deliverer 52 delivers the communication infrastructure information to the onboard device 3 (the communication environment recognizer 17) for which the connection process for connecting to the roadside device 4 has been completed. The delivery of the communication infrastructure information is performed via the roadside wireless communication device 31. Note that the information deliverer 52 can also delivery the communication infrastructure information via the communication the network 6 (see FIG. 1) according to a communication standard (for example, LTE) using a relatively low frequency band.

At least part of the functions of the parts (the communication infrastructure information generator 51, the information deliverer 52) of the information delivery device 5 is realized by executing programs stored in a memory by one or multiple processors. Note that the information delivery device 5 may be configured integrally with the roadside device 4. Also, a part of the process of one of the roadside device 4 and the information delivery device 5 may be alternatively executed by the other. Also, the communication environment recognizer 17 and the travel condition determiner 18 of the onboard device 3 may be provided in the infrastructure system 53 (the roadside device 4 or the information delivery device 5). In other words, at least part of the processes of the communication environment recognizer 17 and the travel condition determiner 18 of the onboard device 3 may be alternatively executed by the infrastructure system 53.

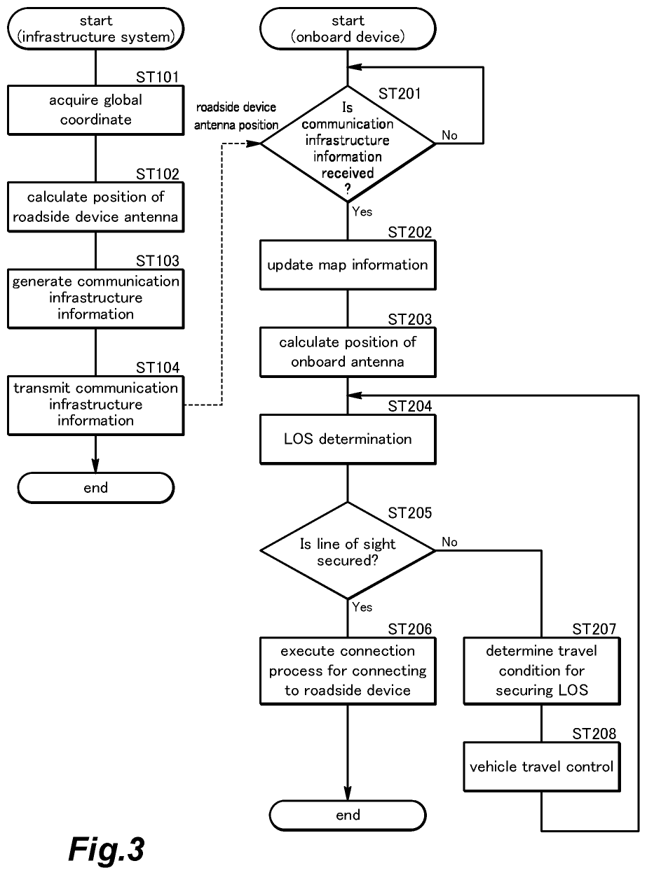

FIG. 3 is a flowchart showing a flow of process for securing a line of sight of wireless communication in the wireless communication system 1.

The infrastructure system 53 acquires the global coordinate of the roadside device 4 (ST101) and calculates the position coordinate of the roadside device antenna 41 based on the global coordinate (ST102).

Next, the infrastructure system 53 generates the communication infrastructure information including the information on the position coordinate of the roadside device antenna 41 (ST103) and transmits the generated information to the onboard device 3 (ST104).

Upon receipt of the communication infrastructure information from the infrastructure system 53 (ST201: Yes), the onboard device 3 updates the three-dimensional map information (ST202). At this time, the position coordinate of the roadside device antenna 41 included in the communication infrastructure information is reflected in the three-dimensional map information.

Then, the onboard device 3 acquires the global coordinate of the vehicle 2 and calculates the position coordinate of the onboard antenna 21 (ST203). Subsequently, the onboard device 3 performs the line of sight (LOS) determination related to wireless communication based on the position coordinate of the onboard antenna 21 and the position coordinate of the roadside device antenna 41 (ST204).

When it is determined that the line of sight between the mobile wireless communication device 11 and the roadside wireless communication device 31 is secured (ST205: Yes), the onboard device 3 executes a connection process for connecting to the roadside device 4 to perform wireless communication (ST206). On the other hand, when it is determined that the line of sight is not secured (ST205: No), the onboard device 3 determines a travel condition for securing the line of sight (LOS) (ST207) and controls the travel of the vehicle 2 according to the travel condition (ST208).

In the process of securing the line of sight of wireless communication, the infrastructure system 53 and the onboard device 3 repeatedly execute the steps as described above.

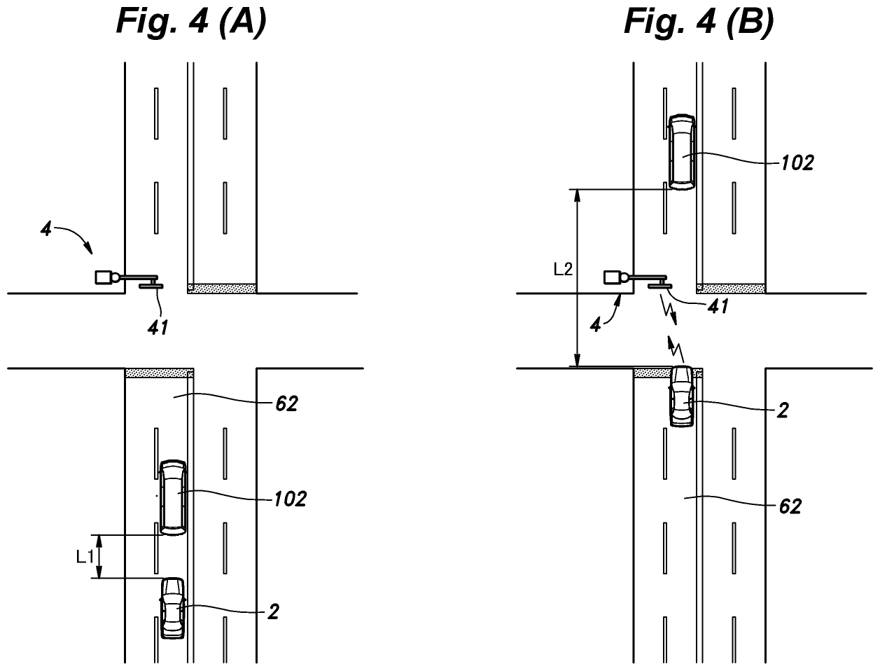

FIG. 4 is an explanatory diagram for showing a first example of travel control of the vehicle 2 according to the travel condition for securing line of sight.

FIG. 4(A) shows a state in which the inter-vehicle distance L1 between the vehicle 2 and another vehicle (large vehicle) 102 traveling ahead in the same right lane 62 is relatively short, and consequently, the line of sight between the onboard antenna 21 (the vehicle 2) and the roadside device antenna 41 (the roadside device 4) is not secured (the line of sight is blocked by another vehicle 102). The roadside device 4 is provided on the left front beyond the intersection.

As a result, the onboard device 3 determines that the line of sight is not secured due to the other vehicle 102 traveling ahead, and then, determines a condition of velocity change (here, deceleration) as the travel condition of the vehicle 2 for securing the line of sight and controls the travel of the vehicle 2 accordingly.

Thereby, as shown in FIG. 4(B) which shows a state when a predetermined time has elapsed from FIG. 4(A), the vehicle 2 can change the inter-vehicle distance to the other vehicle 102 or the like (increase the inter-vehicle distance from L1 to L2). Thus, when the vehicle 2 further approaches the roadside device 4, it is possible to more easily secure the line of sight between the onboard antenna 21 and the roadside device antenna 41.

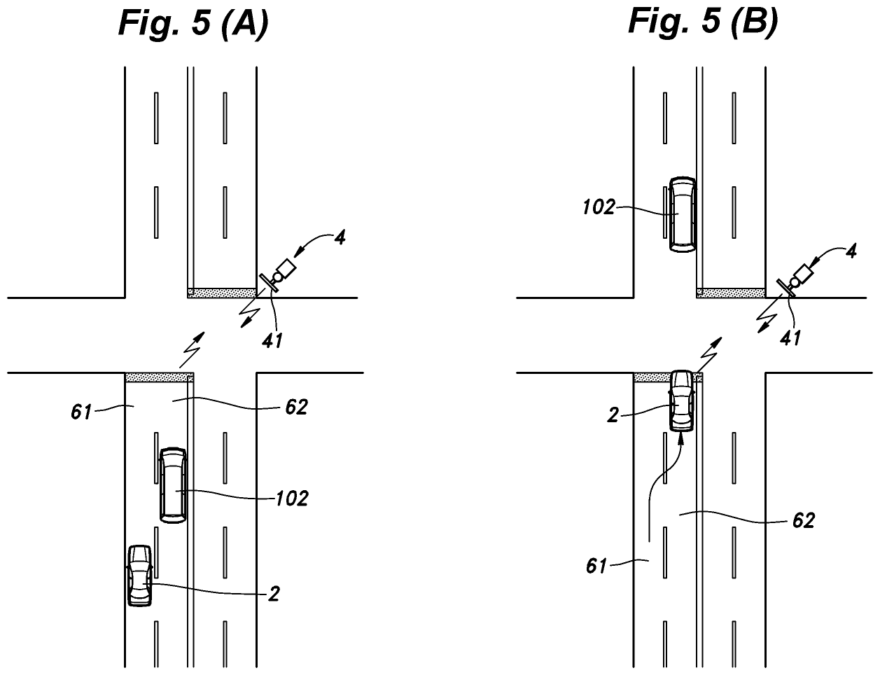

FIG. 5 is an explanatory diagram for showing a second example of travel control of the vehicle 2 according to the travel condition for securing line of sight.

FIG. 5(A) shows a state in which there is another vehicle 102 (large vehicle) traveling in the right lane 62 obliquely ahead of the vehicle 2 traveling in the left lane 61 so that the line of sight between the onboard antenna 21 (the vehicle 2) and the roadside device antenna 41 (the roadside device 4) is not secured (the line of sight is blocked). The roadside device 4 is provided obliquely forward beyond the intersection.

As a result, the onboard device 3 determines that the line of sight is not secured due to the other vehicle 102 traveling obliquely ahead in the right lane 62, and then, determines a condition of handle operation (here, rightward steering) as the travel condition of the vehicle 2 for securing the line of sight and controls the travel of the vehicle 2 accordingly.

Thereby, as shown in FIG. 5(B) which shows a state when a predetermined time has elapsed from FIG. 5(A), the vehicle 2 can change lanes on the multi-lane road (move to the right lane 62 in which the other vehicle 102 is traveling). Thus, when the vehicle 2 further approaches the roadside device 4, it is possible to more easily secure the line of sight between the onboard antenna 21 and the roadside device antenna 41.

Note that in FIGS. 4 and 5, examples in which the line of sight between the onboard antenna 21 and the roadside device antenna 41 is blocked by another vehicle were shown, but the line of sight of wireless communication may be blocked by another object (for example, a roadside tree, a building, etc.). Also, when the line of sight between the onboard antenna 21 and the roadside device antenna 41 is blocked, the vehicle 2 may change the initial travel route by turning right or left, for example, to secure the line of sight.

As described above, according to the wireless communication system 1, it is possible, in the wireless communication between the vehicle 2 and the roadside device 4 provided on the travel route of the moving object, to secure the line of sight between them. Also, due to securing of the line of sight, wireless communication between the vehicle 2 and the roadside device 4 is performed more frequently, and therefore, the electric power efficiency of the wireless communication system 1 (throughput per unit power consumption) is improved.

### Second Embodiment

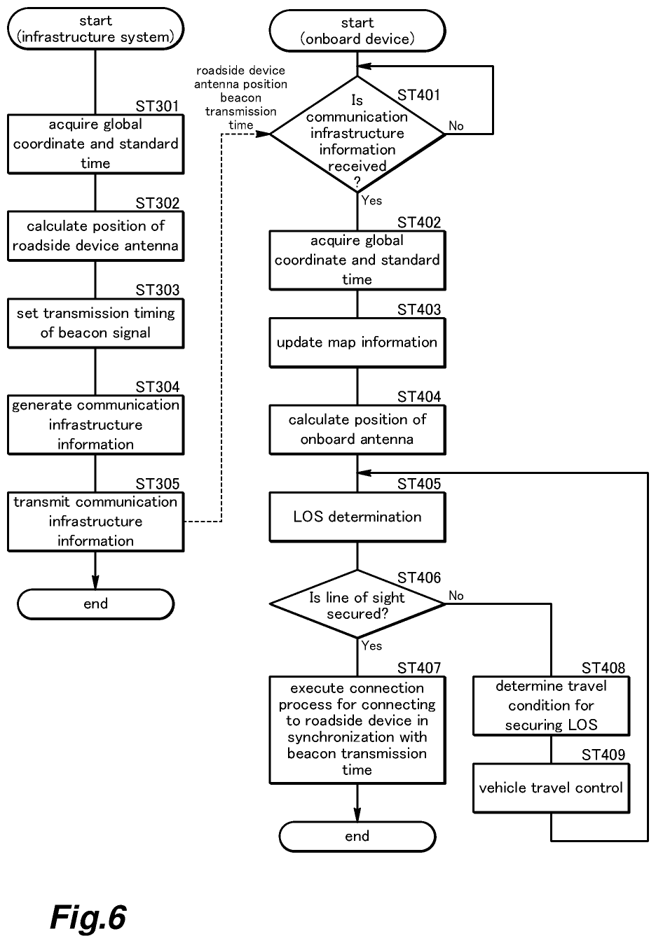

FIG. 6 is a flowchart showing a flow of process for securing a line of sight of wireless communication in a wireless communication system 1 according to the second embodiment. Note that in the wireless communication system 1 according to the second embodiment, the features not particularly mentioned here are the same as in the first embodiment. Also, regarding the wireless communication system 1 according to the second embodiment, components similar to those of the wireless communication system 1 according to the first embodiment will be denoted by identical reference signs and the detailed description thereof will be omitted.

The infrastructure system 53 acquires the global coordinate of the roadside device 4 and the standard time (ST301) and calculates the position coordinate of the roadside device antenna 41 based on the global coordinate (ST302).

Next, the infrastructure system 53 sets the transmission timing of the beacon signal based on the standard time (ST303). If the transmission timing of the beacon signal is already set, step ST303 is omitted. Subsequently, the infrastructure system 53 generates the communication infrastructure information including the position coordinate of the roadside device antenna 41 and the information on the transmission timing (transmission time) of the beacon signal (ST304) and transmits the generated information to the onboard device 3 (ST305). The communication infrastructure information may include information on the channel used in the transmission of the beacon signal.

Upon receipt of the communication infrastructure information from the infrastructure system 53 (ST401: Yes), the onboard device 3 acquires information on the global coordinate of the vehicle 2 and information on the standard time (ST402) and updates the three-dimensional map information (ST403). At this time, the position coordinate of the roadside device antenna 41 included in the communication infrastructure information is reflected in the three-dimensional map information.

Then, the onboard device 3 executes steps ST404-ST409 similarly to steps ST204-ST209 shown in FIG. 3, respectively. Note, however, that in step ST407, the onboard device 3 executes the connection process for connecting to the roadside device 4 in synchronization with the transmission time of the beacon signal from the roadside device 4.

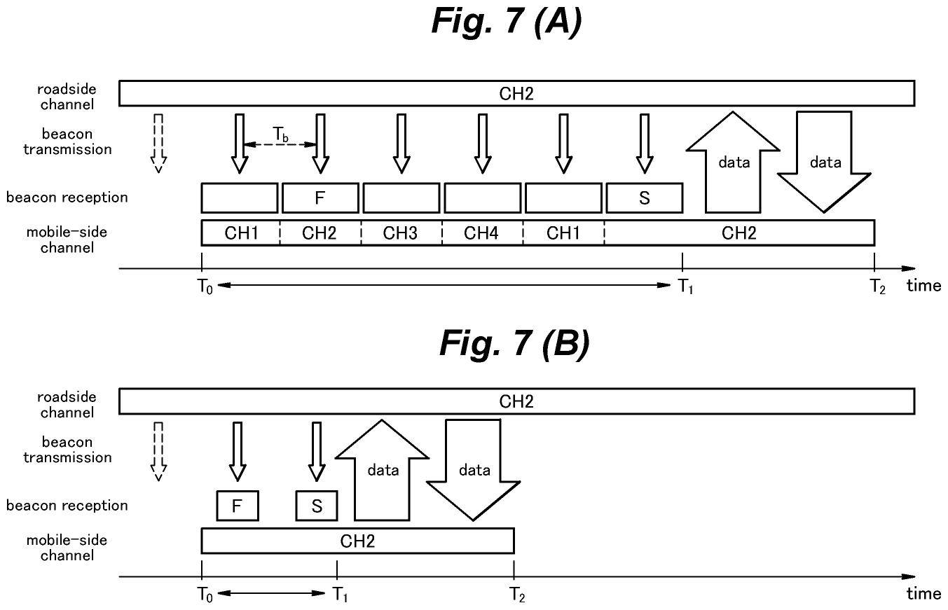

FIG. 7 is an explanatory diagram for showing an example of a connection process for connecting the onboard device 3 to the roadside device 4 that transmits the beacon signal. FIG. 7(A) shows a comparative example and FIG. 7(B) shows the connection process in the wireless communication system 1. In the case shown here, one of four channels (CH1-CH4) is used in the communication between the onboard device 3 (the mobile wireless communication device 11) and the roadside device 4 (the roadside wireless communication device 31).

In the comparative example of FIG. 7(A), the communication channel of the roadside device (hereinafter, the roadside channel) is set in CH2, and the beacon signal is transmitted via this CH2 at a predetermined interval (for example, 100 msec). The onboard device mounted on a traveling vehicle attempts to receive the beacon signal from the roadside device while changing the communication channel (hereinafter, the mobile-side channel) in order at a predetermined interval.

There may be a case where reception of the beacon signal fails (see “F” in the drawing) when the mobile-side channel is first set to CH2 at time T0 in a state in which the onboard device is within the communicable range from the roadside device. In this case, the onboard device cannot receive the transmitted beacon signal until the mobile-side channel is set to CH2 again. Thereafter, the onboard device sets the mobile-side channel to CH2 again at time T1, and succeeds in receiving the beacon signal (see “S” in the drawing). Thereby, the connection process for connecting to the roadside device becomes possible, and at time T2, transmission and reception of necessary data can be completed.

Thus, in the comparative example shown in FIG. 7(A), even when the channel communicable with the roadside device (CH2) is set in the onboard device, if the reception of the beacon signal fails, it takes time till the communicable channel (CH2) is set again.

On the other hand, in the onboard device 3 of the wireless communication system 1, the communication infrastructure information including the information on the transmission timing (transmission time) of the beacon signal is acquired beforehand, and as shown in FIG. 7(B), reception synchronized with this beacon signal is started at time T0. Also, when the information on the roadside channel of the roadside device 4 is acquired beforehand, the onboard device 3 can set the mobile-side channel to be the same as the roadside channel. As a result, in the onboard device 3, even if the reception of the first beacon signal fails (see “F” in the drawing), the next beacon signal can be received (see “S” in the drawing).

Thereby, in the connection process performed by the onboard device 3, a faster (instantaneous) connection process for connecting to the roadside device 4 can be executed and the period from time T0 to T2 becomes shorter compared to the comparative example of FIG. 7(A). Also, in the connection process performed by the onboard device 3, by setting the mobile-side channel to be the same as the roadside channel beforehand, it is possible to stably execute the connection process for connecting to the roadside device 4. Note that since the onboard device 3 performs reception synchronized with the beacon signal even when the information on the roadside channel has not been acquired, it is possible to set the beacon reception interval shorter compared to the comparative example of FIG. 7(A).

### Third Embodiment

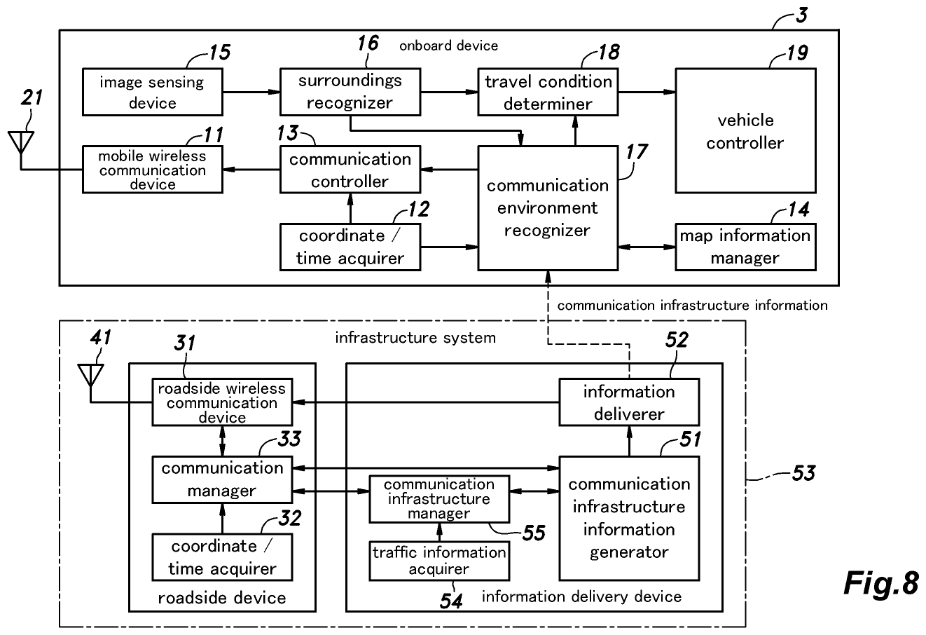

FIG. 8 is a functional block diagram of a wireless communication system 1 according to the third embodiment. Note that in the wireless communication system 1 according to the third embodiment, the features not particularly mentioned here are the same as in the first or second embodiment. Also, regarding the wireless communication system 1 according to the third embodiment, components similar to those of the wireless communication system 1 according to the first or second embodiment will be denoted by identical reference signs and the detailed description thereof will be omitted.

As shown in FIG. 8, the information delivery device 5 according to the third embodiment further includes a traffic information acquirer 54 and a communication infrastructure manager 55 (sleep controller).

The traffic information acquirer 54 acquires traffic information in the planned travel route of the vehicle 2. The traffic information includes traffic light control information, traffic flow information, traffic jam information, traffic restriction information, accident information, weather information, and forecast information of them, for example.

The communication infrastructure manager 55 controls the sleep function of the roadside wireless communication device 31 via the communication manager 33. This sleep function is for temporarily putting the wireless communication by the roadside wireless communication device 31 into hibernation (a state in which the power supply is kept on while saving the electric power). The communication infrastructure manager 55 receives the traffic information from the traffic information acquirer 54 and, based on the traffic information, sets the period of hibernation of the wireless communication in the roadside device 4. This period may be represented by a time zone. For example, the communication infrastructure manager 55 may set night time during which the traffic volume (namely, the volume of wireless communication of the roadside device 4) is relatively low as the period of hibernation of wireless communication. The communication infrastructure manager 55 sends information on the set period of hibernation to the communication infrastructure information generator 51.

When in the hibernation, the roadside wireless communication device 31 stops wireless communication with the onboard device 3. Also, when the hibernation is canceled, the roadside wireless communication device 31 becomes capable of performing wireless communication with the onboard device 3.

The communication infrastructure information generated by the communication infrastructure information generator 51 includes the period of hibernation of wireless communication (hereinafter referred to as sleep timing) in addition to the position coordinate of the roadside device antenna 41.

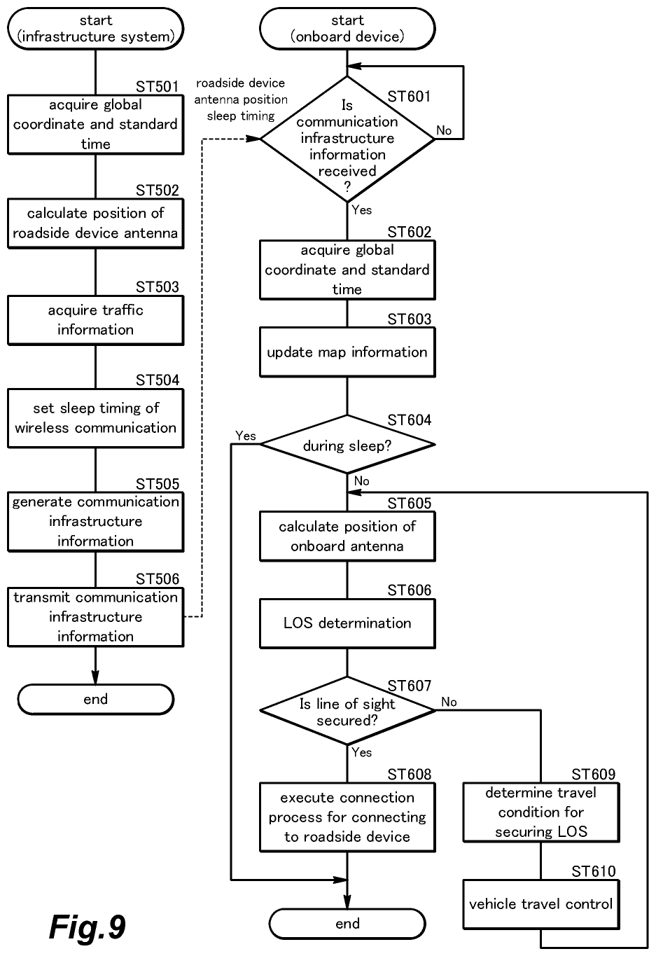

FIG. 9 a flowchart showing a flow of process for securing a line of sight of wireless communication in the wireless communication system 1 according to the third embodiment.

The infrastructure system 53 acquires the global coordinate of the roadside device 4 and the standard time (ST501) and calculates the position coordinate of the roadside device antenna 41 based on the global coordinate (ST502).

Next, the infrastructure system 53 acquires traffic information (ST503) and sets the sleep timing of wireless communication (ST504). Subsequently, the infrastructure system 53 generates the communication infrastructure information including the position coordinate of the roadside device antenna 41 and information on the sleep timing of wireless communication (S505) and transmits the generated information to the onboard device 3 (ST506).

The onboard device 3 executes steps ST601-ST603 similarly to steps ST401-ST403 shown in FIG. 6, respectively. Then, based on the information on the sleep timing, the onboard device 3 determines whether the roadside device 4 that is a communication target is in hibernation (during sleep) (ST604).

When it is determined that the roadside device 4 that is a communication target is in hibernation (ST604: Yes), the onboard device 3 cancels the connection process for connecting to the roadside device 4. On the other hand, when it is determined that the roadside device 4 that is a communication target is not in hibernation (is in operation) (ST604: Yes), the onboard device 3 executes steps ST605-ST610 similarly to steps ST404-ST409 shown in FIG. 6, respectively. Note, however, that in step ST608, synchronization with the transmission time of the beacon signal in step ST407 shown in FIG. 6 is not indispensable.

### Fourth Embodiment

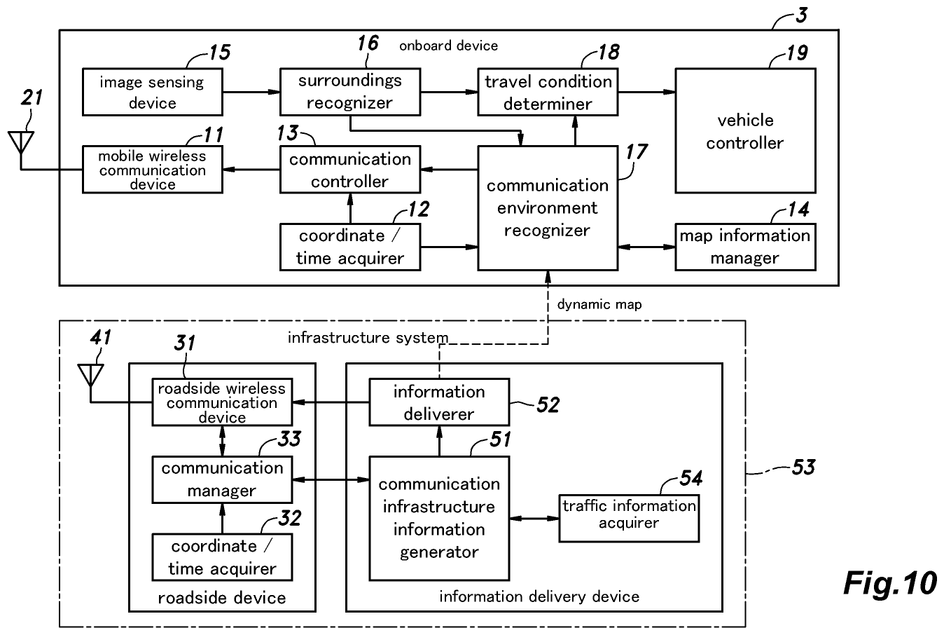

FIG. 10 is a functional block diagram of a wireless communication system 1 according to the fourth embodiment. Note that in the wireless communication system 1 according to the fourth embodiment, the features not particularly mentioned here are the same as in any of the first to third embodiments. Also, regarding the wireless communication system 1 according to the fourth embodiment, components similar to those of the wireless communication system 1 according to any of the first to third embodiments will be denoted by identical reference signs and the detailed description thereof will be omitted.

The traffic information acquirer 54 according to the fourth embodiment further acquires a dynamic map as traffic information of the planned travel route of the vehicle 2. The dynamic map is provided from outside the wireless communication system 1. For example, the dynamic map is provided from the server or the like managed by a company that provides the map data to the infrastructure system 53 via the network 6. The dynamic map is a digital map in which are incorporated static information (for example, three-dimensional map information such as road surface information, lane information, and building position information), quasi-static information (for example, traffic restriction schedule, road construction schedule, and wide-area weather forecast information), quasi-dynamic information information (for example, accident information, traffic jam information, traffic restriction information, and narrow-area weather information), and dynamic information (for example, real-time information such as nearby vehicle information, pedestrian information, traffic light information, and so on) for autonomous travel. Note that the dynamic map does not necessarily have to include all information included in such static information, quasi-static information, dynamic information, and dynamic information, and may be configured by selecting desired pieces of information therefrom.

The communication infrastructure information generator 51 generates, as the communication infrastructure information, the dynamic map having the position coordinate of the roadside device antenna 41 added thereto. Also, the communication infrastructure information generator 51 delivers the generated dynamic map to the onboard device 3.

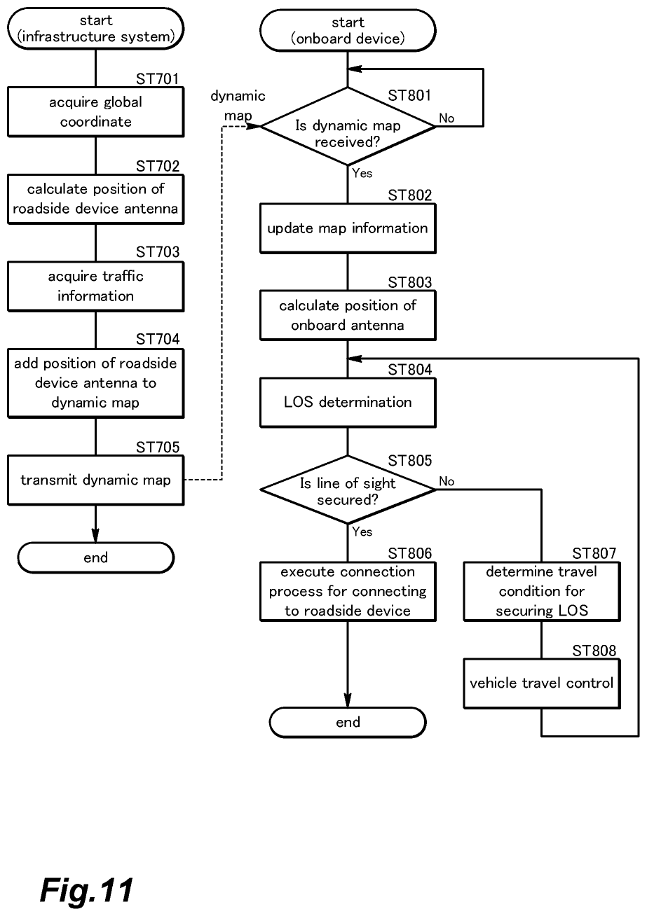

FIG. 11 is a flowchart showing a flow of process for securing a line of sight of wireless communication in the wireless communication system 1 according to the fourth embodiment.

The infrastructure system 53 acquires the global coordinate of the roadside device 4 (ST701) and calculates the position coordinate of the roadside device antenna 41 based on the global coordinate (ST702).

Next, the infrastructure system 53 acquires traffic information (ST703) and adds the position coordinate of the roadside device antenna 41 to the dynamic map (ST704). Then, the infrastructure system 53 delivers this dynamic map to the onboard device 3 (ST705).

Upon receipt of the dynamic map from the infrastructure system 53 (ST801: Yes), the onboard device 3 updates the three-dimensional map information (ST802).

Then, the onboard device 3 acquires the global coordinate of the vehicle 2 and calculates the position coordinate of the onboard antenna 21 (ST803). Subsequently, the onboard device 3 performs the line of sight (LOS) determination related to wireless communication based on the position coordinate of the onboard antenna 21 and the position coordinate of the roadside device antenna 41 (ST804).

Thereafter, the onboard device 3 executes steps ST804-ST808 similarly to steps ST204-ST208 shown in FIG. 3, respectively.

### Fifth Embodiment

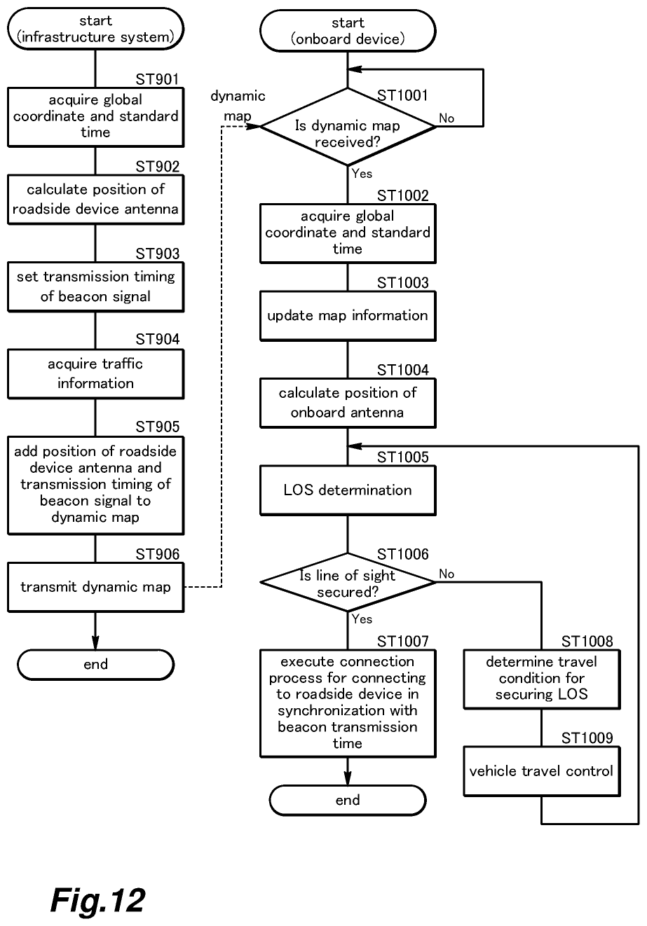

FIG. 12 is a flowchart showing a flow of process for securing a line of sight of wireless communication in a wireless communication system 1 according to the fifth embodiment. Note that in the wireless communication system 1 according to the fifth embodiment, the features not particularly mentioned here are the same as in any of the first to fourth embodiments. Also, regarding the wireless communication system 1 according to the fifth embodiment, components similar to those of the wireless communication system 1 according to any of the first to fourth embodiments will be denoted by identical reference signs and the detailed description thereof will be omitted.

The infrastructure system 53 executes steps ST901-ST903 similarly to steps ST301-ST303 shown in FIG. 6, respectively.

Next, the infrastructure system 53 acquires traffic information (ST904) and adds the position coordinate of the roadside device antenna 41 and the information on the transmission timing (transmission time) of the beacon signal to the dynamic map (ST905). Then, the infrastructure system 53 delivers this dynamic map to the onboard device 3 (ST906).

Upon receipt of the dynamic map from the infrastructure system 53 (ST1001: Yes), the onboard device 3 executes steps ST1002-ST1009 similarly to steps ST402-ST409 shown in FIG. 6, respectively.

### Sixth Embodiment

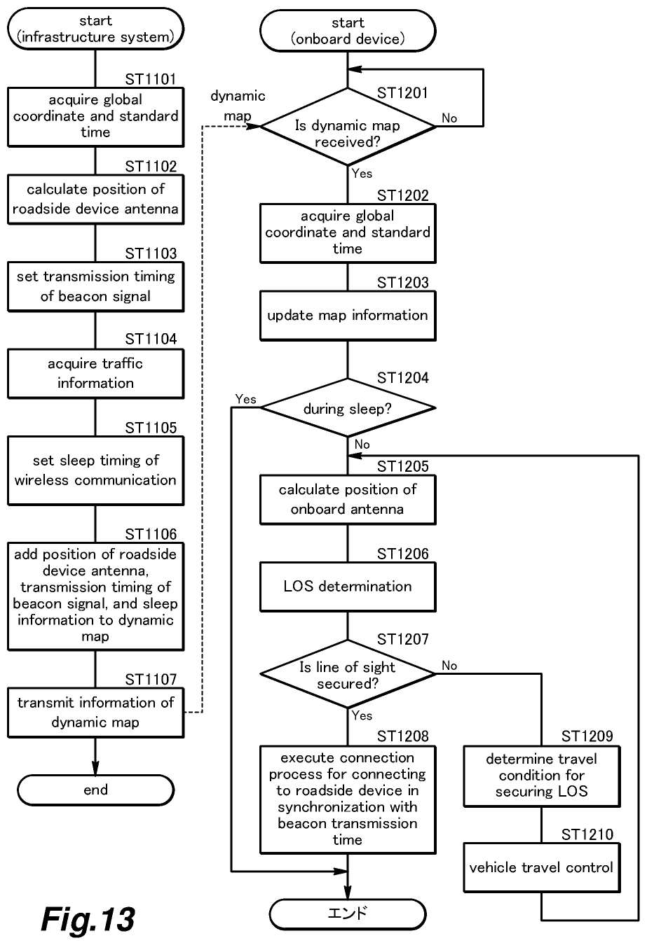

FIG. 13 is a flowchart showing a flow of process for securing a line of sight of wireless communication in a wireless communication system 1 according to the sixth embodiment. Note that in the wireless communication system 1 according to the sixth embodiment, the features not particularly mentioned here are the same as in any of the first to fifth embodiments. Also, regarding the wireless communication system 1 according to the sixth embodiment, components similar to those of the wireless communication system 1 according to any of the first to fifth embodiments will be denoted by identical reference signs and the detailed description thereof will be omitted.

The infrastructure system 53 executes steps ST1101-ST1103 similarly to steps ST901-ST903 shown in FIG. 12, respectively.

Next, the infrastructure system 53 acquires traffic information (ST1104) and sets the sleep timing of wireless communication (ST1105). Also, the infrastructure system 53 adds the position coordinate of the roadside device antenna 41, the information on the transmission timing (transmission time) of the beacon signal, and the information on the sleep timing of wireless communication to the dynamic map (ST1106). Then, the infrastructure system 53 delivers this dynamic map to the onboard device 3 (ST1107).

Upon receipt of the dynamic map from the infrastructure system 53 (ST1201: Yes), the onboard device 3 executes steps ST1202 and ST1203 similarly to steps ST1002 and ST1003 shown in FIG. 12, respectively.

Next, based on the information on the sleep timing, the onboard device 3 determines whether the roadside device 4 that is a communication target is in hibernation (during sleep) (ST1204), and thereafter executes steps ST1205-ST1210 similarly to steps ST605-ST610 shown in FIG. 9, respectively. Note, however, that in step ST1208, the onboard device 3 executes the connection process for connecting to the roadside device 4 in synchronization with the transmission time of the beacon signal from the roadside device 4.

As described above, embodiments have been described as examples of the technology disclosed in the present application. However, the technology of the present disclosure is not limited thereto and may also be applied to embodiments in which changes, substitutions, additions, omissions, etc. may be made. In addition, it is also possible to combine the constituent elements described in the above embodiments to yield a new embodiment.

For example, the moving object in the wireless communication system 1 may be a shuttle bus (autonomous vehicle) at an airport, an autonomous moving cart in a terminal building, a truck (autonomous vehicle) for loading onto the ferry at the port, a vehicle for transporting material or lumber at the factory, etc. Further, the moving object of the wireless communication system 1 may be an autonomous cleaning robot, a security monitoring robot, or the like for use in buildings, offices, and houses.

Also, in the above-described embodiments, the roadside device 4 provided on the travel route of the vehicle 2 does not necessarily have to be a device that is permanently installed, and may be a portable device that is temporarily installed (namely, position is fixed). Further, the fixed communication device that communicates with the mobile communication device mounted on the moving object does not necessarily have to be provided in the roadside device 4. For example, the fixed communication device may be provided in a moving device such a drone. In this case, the fixed communication device communicates with the moving object (mobile communication device) in a state in which the moving device is temporarily installed (namely, in the state in which the moving device stops in a predetermined position).

### INDUSTRIAL APPLICABILITY

The wireless communication system and the wireless communication method according to the present disclosure have an effect that in wireless communication between a mobile communication device mounted on a moving object and a fixed communication device provided on a travel route of the moving object, the line of sight (LOS) between them can be secured, and are useful as a wireless communication system and a wireless communication method for performing wireless communication between a mobile communication device mounted on a moving object and a fixed communication device provided on a travel route of the moving object.

### LIST OF REFERENCE NUMERALS

1 wireless communication system
2 vehicle (moving object)
3 onboard device
4 roadside device
5 information delivery device
6 communication network
11 mobile wireless communication device (mobile communication device)
12 coordinate/time acquirer
13 communication controller (mobile-side communication controller)
14 map information manager
15 image sensing device
16 surroundings recognizer
17 communication environment recognizer (LOS determiner)
18 travel condition determiner
19 vehicle controller
21 onboard antenna
31 roadside wireless communication device (fixed communication device)
32 coordinate/time acquirer
33 communication manager
41 roadside device the antenna
51 communication infrastructure information generator
52 information deliverer
53 infrastructure system
54 traffic information acquirer
55 communication infrastructure manager
61 left lane
62 right lane
102 another vehicle

1. A wireless communication system for performing wireless communication between a mobile communication device mounted on a moving object and a fixed communication device provided on a travel route of the moving object, the system comprising:
an LOS determiner that determines whether a line of sight between the mobile communication device and the fixed communication device is secured based on position information of the fixed communication device and position information of the mobile communication device; and
a travel condition determiner that, when it is determined by the LOS determiner that the line of sight is not secured, determines a travel condition of the moving object for securing the line of sight.

2. The wireless communication system according to claim 1, further comprising a mobile-side communication controller that is mounted on the moving object and controls a connection process for connecting the mobile communication device to the fixed communication device,
wherein the mobile-side communication controller executes the connection process only when it is determined by the LOS determiner that the line of sight is secured.

3. The wireless communication system according to claim 1, wherein the position information of the fixed communication device is based on position of an antenna provided on the fixed communication device.

4. The wireless communication system according to claim 1, wherein the position information of the mobile communication device includes a position coordinate of the mobile communication device in three-dimensional map information.

5. The wireless communication system according to claim 4, wherein the position information of the fixed communication device includes a position coordinate of the fixed communication device in the three-dimensional map information, and
the LOS determiner determines that the line of sight is not secured when there is another object on a straight line connecting the position coordinate of the fixed communication device and the position coordinate of the mobile communication device.

6. The wireless communication system according to claim 1, further comprising an image sensing device that is mounted on the moving object and captures an image of the fixed communication device thereby to generate a captured image,
wherein the LOS determiner determines whether the line of sight between the mobile communication device and the fixed communication device is secured based on the captured image.

7. The wireless communication system according to claim 3, wherein the position information of the fixed communication device is based on a position of a guide sign installed together with the antenna.

8. The wireless communication system according to claim 1, wherein the moving object is an autonomous vehicle, and the travel condition includes at least one of a velocity of the autonomous vehicle, an inter-vehicle distance to another vehicle traveling ahead, and a traveling lane.

9. The wireless communication system according to claim 2, wherein the fixed communication device transmits a beacon signal to surroundings at a predetermined period and is further provided with a beacon controller that sets transmission timing of the beacon signal, and
the mobile-side communication controller controls the connection process for connecting the mobile communication device to the fixed communication device so as to synchronize with the transmission timing of the beacon signal.

10. The wireless communication system according to claim 2, further comprising a sleep controller for placing the fixed communication device into hibernation,
wherein the LOS determiner cancels the determination when the fixed communication device is in hibernation.

11. The wireless communication system according to claim 9, wherein the mobile-side communication controller acquires information on the transmission timing of the beacon signal together with a dynamic map provided from outside the wireless communication system.

12. The wireless communication system according to claim 10, wherein the mobile-side communication controller acquires information on whether the mobile communication device is in hibernation together with a dynamic map provided from outside the wireless communication system.

13. The wireless communication system according to claim 1, wherein the mobile communication device acquires the position information of the mobile communication device together with a dynamic map provided from outside the wireless communication system.

14. A wireless communication method for performing wireless communication between a mobile communication device mounted on a moving object and a fixed communication device provided on a travel route of the moving object, the method comprising:
determining whether a line of sight between the mobile communication device and the fixed communication device is secured based on position information of the fixed communication device and position information of the mobile communication device; and
determining a travel condition of the moving object for securing the line of sight when it is determined that the line of sight is not secured.
